(19) United States
(12) Patent Application Publication
(10) Pub. No.: US 2018/0248221 A1
(43) Pub. Date: Aug. 30, 2018

(54) SYSTEM AND METHOD FOR A STABLE HIGH TEMPERATURE SECONDARY BATTERY

(71) Applicant: Cuberg, Inc., Mountain View, CA (US)

(72) Inventors: Richard Y. Wang, Albany, CA (US); Mauro Pasta, Ocford (GB); Olivia Risset, Oakland, CA (US); Chien-Fan Chen, Pleasant Hill, CA (US)

(21) Appl. No.: 15/904,315

(22) Filed: Feb. 24, 2018

Related U.S. Application Data
(60) Provisional application No. 62/463,194, filed on Feb. 24, 2017.

(51) Int. Cl. H01M 10/0525; H01M 10/0568; H01M 10/0569; H01M 4/134; H01M 4/13; H01M 4/38; H01M 4/46; H01M 4/48; H01M 4/62; H01M 2/06; H01M 2/02; H01M 2/16; H01M 10/0587; H01M 10/04

(52) U.S. Cl. CPC H01M 10/0525; H01M 2300/0045; H01M 10/0569; H01M 4/134; H01M 4/13; H01M 4/382; H01M 4/466; H01M 4/483; H01M 4/622; H01M 4/625; H01M 2/065; H01M 2/0285; H01M 2/1686; H01M 2/1646; H01M 2/1653; H01M 10/0587; H01M 10/0427; H01M 10/0568

(57) ABSTRACT

A system for a high temperature, high energy density secondary battery that includes an electrolyte comprising an ionic liquid solvent, and electrolyte salts; a metallic anode; a cathode, compatible with the electrolyte and comprising an active material and a polyimide binder; and a separator component that separates the cathode and anode.

### CROSS-REFERENCE TO RELATED APPLICATIONS

This Application claims the benefit of U.S. Provisional Application No. 62/463,194, filed on Feb. 24, 2017, which is incorporated in its entirety by this reference.

### GOVERNMENT RIGHTS

This invention was made with government support under the Cooperative Research and Development Agreement No. FP00003662 with the Regents of the University of California Ernest Orlando Lawrence Berkeley National Laboratory under its US Department of Energy No. DE-ACO2-5CH11231. The government has certain rights in the invention.

### TECHNICAL FIELD

This invention relates generally to the field of rechargeable batteries, and more specifically to a new and useful system and method for a stable high-energy rechargeable battery.

### BACKGROUND

Batteries are used in various industries, such as consumer electronics, electric vehicles, measurement/logging while drilling, aerospace, medical devices, portable power devices, military, oil and gas, and so forth. Batteries are known to achieve optimum performance when operated around room temperature but at high temperatures batteries become unstable and dangerous, and charge and discharge inefficiently. Although challenging, battery operation in harsh environments is essential in various industries including automotive, oil and gas, military and medical devices. Generally, commercially available rechargeable batteries do not safely and reliably function above 70° C. Furthermore, they do not provide the high energy density used in specific markets such as oil and gas drilling equipment.

Thus, there is a need in the rechargeable battery field to create a new and useful system and method for a stable high-energy rechargeable battery. This invention provides such a new and useful system and method.

### BRIEF DESCRIPTION OF THE FIGURES

FIG. 1 is a schematic diagram of the system as a spiral-wound cell battery;

FIG. 2 is a cross-sectional diagram of an exemplary implementation of the system;

FIG. 3 is a schematic diagram of the system as a button cell battery;

FIG. 4 is a schematic diagram of the system as a pouch cell battery;

FIG. 5 is a chart comparing battery performance for variable salt concentrations at elevated temperatures;

FIG. 6 is a cross sectional diagram showing an exemplary implementation of the system with a dual layer separator;

FIG. 7 is a chart comparing battery performance for different binders at elevated temperatures;

FIG. 8 is a detailed schematic representation of a high temperature battery casing; and

FIG. 9 is a schematic representation of a battery charging system.

### DESCRIPTION OF THE EMBODIMENTS

The following description of the embodiments of the invention is not intended to limit the invention to these embodiments but rather to enable a person skilled in the art to make and use this invention.

### Overview

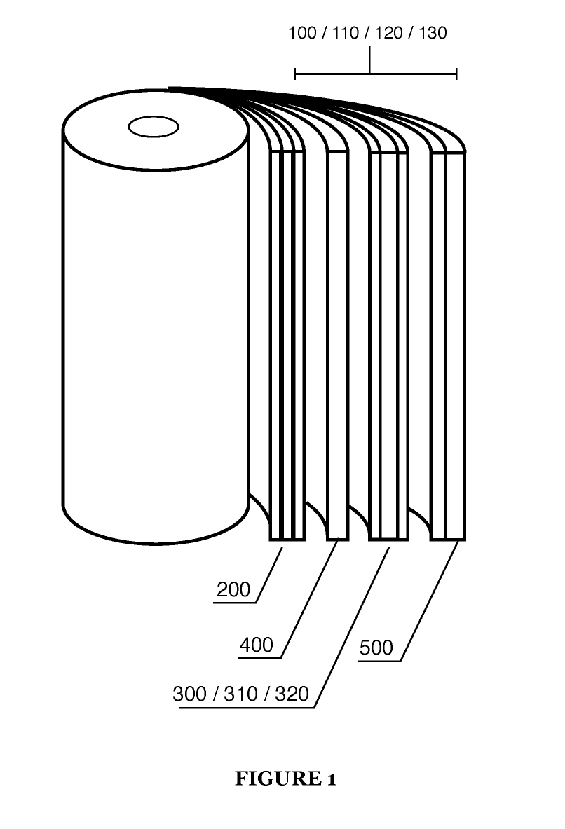

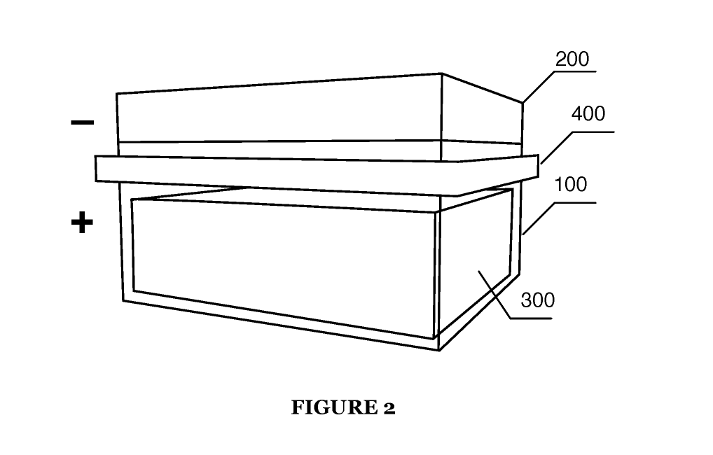

As shown in FIG. 1 and more generally in FIG. 2, a system for a high temperature, high energy density secondary battery of a preferred embodiment can include an electrolyte 100 that includes an ionic liquid solvent 110, lithium salts 120, and stabilizing salts 130; a metallic anode 200; a metal oxide cathode 300, compatible with the electrolyte; and at least one separator 400 that separates the cathode and anode. Preferably, the cathode comprises a polyimide binder 310. Herein, references to the battery may describe the full system or a device in which the system is a subcomponent. The system may additionally include a battery casing 500, multiple battery units acting as cells within a multi-cell battery, and/or any suitable battery component. The system may additionally include a charger system 600. The charger system 600 in combination with the battery may provide particular recharging capabilities to the battery. The system may additionally include integrated or coupled electrical devices in which the battery may be applicable such as well or mining measurement and logging device, a drilling device, a medical device, medical devices (e.g., electrical medical device implants), aerospace, wearable devices, and/or other suitable applications.

The system preferably leverages a set of compatible components that can be used in enabling a nonvolatile and nonflammable battery. Many of the components described herein offer high thermal stability (e.g., stable up to 250° C.), and a battery using these components can be particularly applicable where a battery is used in elevated temperatures. Elevated temperatures for the battery may be considered as temperatures above 50° C., but many implementations may be suitable for temperatures above 100° C., 150° C., and even greater than 180° C. As a more specific description, high performance of the battery can stem from a wide electrochemical window that allows for use of high voltage (greater than 4 V versus lithium at full state of charge) cathode materials even at elevated temperature, combined with unique chemical properties that result in the stabilization of an energy-dense metallic anode. Overall, synergistic effects between carefully selected battery components and electrolyte can give rise to a unique battery with the potential to safely deliver high energy density and specific energy at elevated temperatures, and in a rechargeable configuration as discovered by the applicant.

In one implementation, the system may enable a battery to run at an average voltage of 3.7V, providing 80 Wh in a DD-format cell (cell volume of around 100 cubic cm), at temperatures of up to at least 160° C. Additionally such an exemplary battery could be substantially nonflammable and rechargeable. The battery may alternatively have other suitable operating properties.

As one potential benefit, the battery of the system may contain components stable and functioning at high temperatures (up to and/or above 160° C.). This could allow the battery to be operable and safe in specific markets such as oil and gas drilling equipment, where batteries have to tolerate extreme heat.

In addition to high temperature use, another potential benefit could be that the battery of the system may be both stable at high temperatures and rechargeable. The battery can provide a unique combination of high temperature stability and rechargeability features while providing comparable or better energy properties than other technologies. These qualities have the potential to greatly benefit military applications, drilling applications, and/or other suitable applications.

As another potential benefit, the battery of the system may be produced by components that are non-flammable and in general safe. Safe batteries may have particular applications in the private sector and in medical applications where people or sensitive equipment can be vulnerable to issues with the battery. High-energy medical devices that are currently too risky to use or carry on a person for extended periods can be made much safer due to this battery. Similarly, use of rechargeable batteries in situations with low thresholds for battery failure like downhole drilling can similarly be made safer.

As another potential benefit, the battery of the system may be produced using materials and approaches that offer significant cost savings over other battery options currently in use where the other comparable batteries generally lack many of the features of this system (e.g., rechargeability, safety, stability, etc.). One example of cost savings can be where an implementation of the battery in a DD-format cell could be offered at a cost range of $10-20 per discharge where a comparable battery in a DD-format cell, such as a lithium thionyl chloride battery or a lithium carbon monofluoride battery, may cost between $30-$40 per discharge.

As another potential benefit, the system may offer a low weight and volume profile compared to other battery technologies. This can lead to the creation of new medical devices that have to this day been infeasible. Neurological stimulators of the spinal cord and implanted defibrillators are such examples.

The system can have particular applicability to use cases in highly-instrumented and power-hungry downhole drills and probes. In such use cases, safety and stability are highly important. Short-circuiting, electrical degradation, mechanical degradation, thermal degradation, and/or explosions from overheating could cause significant complications to such downhole operations. The system and method may provide applicability for electric vehicles where range anxiety due to current batteries' lack of sufficient power and lack of portability make long range trips difficult. The system may also provide a large market applicability in personal electronics, where stability is a major factor. In addition, the long term discharge of the battery with stability can have particular interest for military usage. The aerospace industry can also potentially reap benefits from a battery that is temperature resistant, stable, and long lasting.

The battery of a preferred embodiment includes internal battery components and external components. The internal battery components provide the electrochemical processes enabling recharging and discharging. The external, or casing, components can be used in packaging and securing the internal battery components.

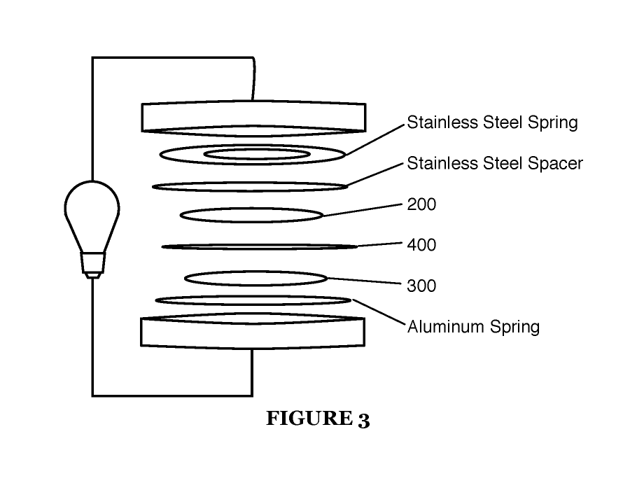

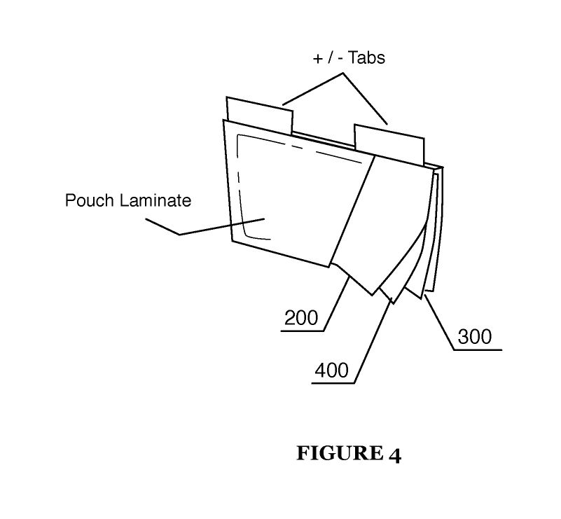

The internals of the battery can include inert components (e.g., the separator, foils, tabs, etc.) and active components (e.g., metal oxide cathode and metallic anode). Preferably, the battery includes an anode subcomponent and cathode subcomponent, wherein the anode and cathode subcomponents are separated by the separator 400. The interior space of the battery, between the cathode and the anode and including the porous space of the separator 400 and the cathode 300, is preferably filled with the electrolyte 100. A battery of the system will additionally include an anode terminal and a cathode terminal as part of the external components. The cathode and anode may be electrically connected to their respective terminal ends with metallic spacers or springs, but can also be connected with a metallic tab. The battery internals are preferably encased in a battery casing 500. The casing 500 can be a metallic structure used in packaging the internal components. In one implementation, the casing 500 can include an interior metallic coating and steel exterior. Various types of battery formats may be made such as a button cell as shown in FIG. 3, a spiral-wound battery as shown in FIG. 1, a pouch cell battery as shown in FIG. 4, and/or any suitable form of battery. The shape of the battery can be, but is not limited to, cylindrical, prismatic solid or any suitable shape.

An electronic device can be conductively coupled to the anode and cathode terminals to use the battery as an energy source, wherein the battery can be operated in a discharging mode. A charging system 600 may also conductively couple to the anode and cathode terminals to facilitate charging the battery, wherein the battery is operated in a charging mode.

### Electrolyte

The electrolyte 100 of a preferred embodiment functions to serve as an ion carrier in the battery, promoting ionic flow between the cathode and anode. The electrolyte 100 is preferably a blend of non-aqueous liquid from the ionic liquid family with high thermal stability. More specifically, the electrolyte 100 for a lithium battery can be comprised of electrolyte salts, a complementary non-aqueous ionic liquid solvent, and optionally additional salts and additives to stabilize the system. The complementary nature of the solvent can allow for dissolution of the salt at preferred parameters of the system. The electrolyte 100 may facilitate the use of both metallic anodes and high-voltage cathodes, thereby enabling a battery with high specific energy and/or energy density in a stable and/or rechargeable format. A preferred blend of electrolyte may be described as nonflammable, forming a thermally-stable electrolyte 100 for a high-energy rechargeable battery. In some preferred variations, solvents and/or additives may improve coulombic efficiency, reduce gassing, and/or reduce side reactions with metallic anodes and/or high voltage cathodes. In preferred examples, improved coulombic efficiency, reduced gassing, and/or reduced side reactions may occur at high temperatures. In some preferred variations, the additives may promote uniform lithium deposition, thereby improving battery reliability and/or cyclability. Cyclability may be associated with one of two potential metrics: power ability (i.e., how fast a battery can be cycled) and battery lifetime (i.e., number of cycles before reaching end of life (EOL)). Cyclability may be temperature dependent. End of life may be characterized by when retention is less than 80% of the initial capacity. A cycle can be characterized as a substantially complete cycle between a full state of charge and a particular depth of discharge. Cyclability may be temperature dependent. In one example, the battery can be discharged in <5 h and undergo 80 cycles at 110° C.; the battery can be discharged in <10 h and undergo 12 cycles at 150° C.

In a preferred example, a nonvolatile and nonflammable electrolyte 100 may be thermally stable up to and above 250° C.

A preferred variation of electrolyte 100 is comprised of electrolyte salts or more specifically lithium salts 120. These salts dissolve into ions that conduct charges within the liquid medium, thus making the wettability of the separator and cathode components an important factor in the battery performance. In a preferred example, the lithium salt 120 concentration is high. The electrolyte salts can be 10-30 percent of the total weight of the electrolyte 100. In one implementation, a high concentration of lithium salt 120 is greater than 15% by weight. In one implementation this may include a lithium salt 120 concentration of 18-22% by weight. At typical operating temperatures (i.e. room temperature) high lithium salt concentration may induce high viscosity in the electrolyte 100, which is commonly considered detrimental to battery performance. However, as discovered by the applicant, high lithium salt concentration and its application in a commercial battery implementation for use cases as described herein (e.g., high temperature) may have particular benefits. Some potential benefits related to high salt concentration can include improved uniformity of lithium plating, increased ionic conductivity, higher oxidative stability, and/or other suitable benefits. For a system with preferred components, high lithium salt concentration may allow the system to function better at higher temperatures such as temperatures that are considered nonfunctional for typical rechargeable batteries (i.e. >70° C.).

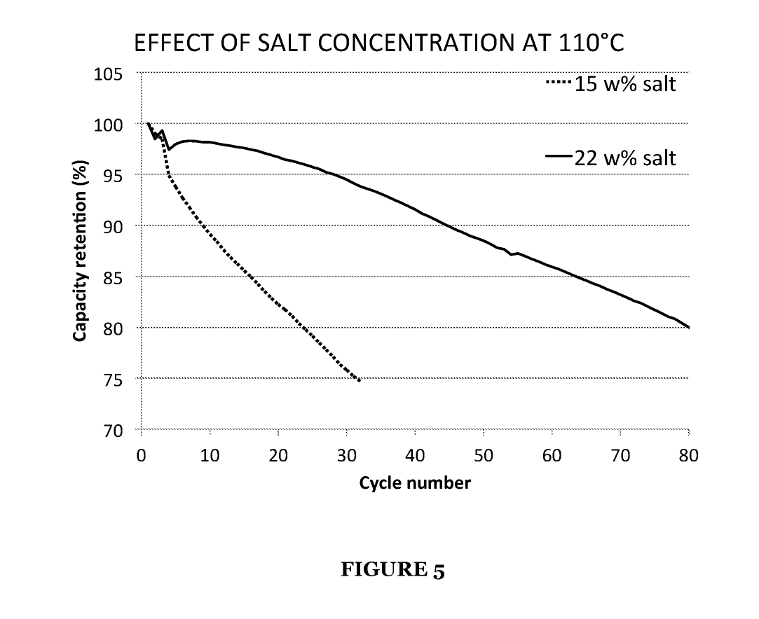

As shown in FIG. 5, the concentration of electrolytic salt can provide significant improvements compared to more conventional concentration levels. In this exemplary chart, the battery with 22% by weight of salt retains approximately 80% of capacity after 80 cycles while a battery with 15% by weight of salt may lose 20% of capacity after 25 cycles.

Examples of lithium salts include: lithium bis(fluorosulfonyl)imide, lithium hexafluorophosphate, lithium bis(oxalato)borate, or lithium tetrafluoroborate. One preferred implementation of lithium salt is lithium bis(trifluoromethanesulfonyl)imide (LiTFSI). In one implementation, the LiTFSI accounts for 27% of the electrolyte weight.

The liquid solvent 110 is preferably a nonaqueous aprotic solvent, which may contain an alkyl-substituted pyrrolidinium or piperidinium cation and an imide anion. The anion can include a sulfonyl group. One preferred example of the ionic liquid solvent is a bis(trifluoromethanesulfonyl)imide (TFSI)-based ionic liquid solvent. A more preferred implementation may be 1-Butyl-1-methylpyrrolidinium bis(trifluoromethanesulfonyl)imide. Alternative ionic liquid materials can include molecularly related compounds by replacing pyrolidinium with piperidinium, replacing butyl with alkyls of different length (e.g. methyl, ethyl, and the like), replacing methyl with alkyls of different length (e.g. butyl, ethyl, and the like), replacing bis(trifluoromethanesulfonyl)imide (TFSI) with bis(fluorosulfonyl)imide (FSI), and/or any of these or other suitable combinations. The ionic liquid solvent can serve as the medium for ionic flow, increase the thermal stability of the system, and promote even electroplating of ions onto the anode.

Stabilizing salts and/or other additives 130 can function to tune the physical and chemical properties of the electrolytes (e.g. viscosity, electrochemical stability, thermal stability, transference number, diffusivity, and conductivity). In preferred variations, salts and additives stabilize the electrolyte 100 at high temperatures, which may increase battery life at high temperature cycling, increase the wettability of the various porous components (i.e. separator and cathode), and/or convey other desired properties on the electrolyte 100. In some examples, stabilizing salts 130 and additives may include sodium bis(trifluoromethanesulfonyl)imide, potassium bis(trifluoromethanesulfonyl)imide, cesium bis(trifluoromethanesulfonyl)imide, magnesium bis(trifluoromethanesulfonyl)imide, and/or zinc bis(trifluoromethanesulfonyl)imide. Other suitable salts and/or additives may be used.

### Separator

The separator 400 of a preferred embodiment functions as a physical barrier between the anode and cathode subcomponents and facilitates desired electrochemical interactions by promoting ionic flow between the negative and positive electrodes. The separator 400 sits between the cathode and anode insuring no electrical contact between the two. The separator 400 can be an electronically insulating membrane disposed between the negative and positive electrodes, but may alternatively be any suitable type of separating structure. Separators 400 are preferably porous structures that, although ion-permeable, are not electrically conductive. In one implementation, the contact angle of the electrolyte 100 on the separator surface is less or equal to 60°, as measured 60 seconds after deposition. If the contact angle of the liquid drop on the material is lesser than 60 degrees, the interactions between the liquid and material are favorable and the material can be considered wet. In one exemplary implementation, the separator thickness is less than or equal to 35 microns. Depending on their composition, separators 400 may have additional properties in addition to the ones previously mentioned (e.g. a ceramic coating may increase separator mechanical strength and increase separator stability at high temperatures). Possible separator examples are: surfactant-coated separators, ceramic-coated polyethylene, non-coated polypropylene, non-coated polyethylene, or polyimide (either by itself or in combination with one of the other prior options). In one preferred implementation, the separator 400 may be a ceramic-coated polypropylene separator. The ceramic coat can function to give the separator 400 additional thermal and mechanical stability. Polypropylene can have favorable interactions with the electrolyte that enhance wettability, which promotes ion transfer and mitigates dendritic growth on the anode. In one exemplary implementation, the separator may have: pore size<200 nm; porosity>35%; tensile strength>90 kfg/cm2; Gurley number>4 sec/100 mL; Density>6 g/m2; and/or a melting temperature>110° C. In such an exemplary implementation shrinkage at 90° C. for 2 h could be less than 3% and shrinkage at 105° C. for ih could be less than 5%. The separator is compatible with the preferred electrolyte 100.

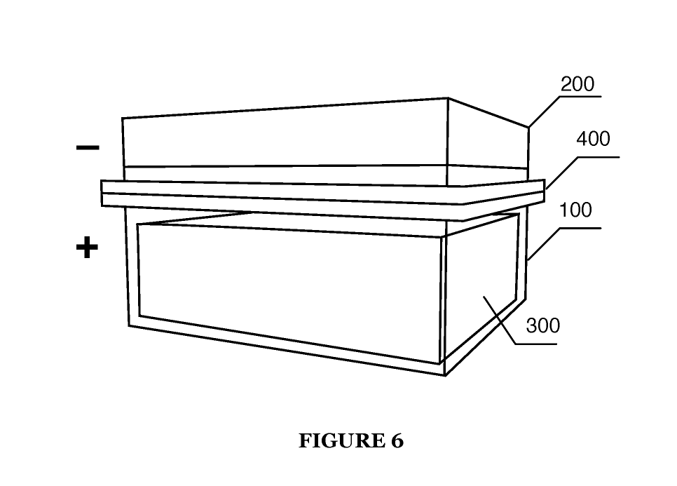

A separator 400 may be a single component separator as described previously. The separator 400 may alternatively be a compound separator made of multiple single component separators, layers, and/or other materials. A compound separator may be a dual layer separator that has an anode-adjacent surface and/or a cathode adjacent surface as shown in FIG. 6. In a preferred variation, the anode-adjacent separator is composed of the ceramic coated polypropylene layer (as described above) and the cathode-adjacent separator is composed of a polyimide layer. In this implementation the polyimide may function to provide additional mechanical robustness to the separator 400 to avoid degradation, deformations, or other forms of failures at high temperatures. In some implementations, such a separator 400 may be suitable up to at least 200° C.

### Anode

The anode 200, or negatively charged electrode, of a preferred embodiment is a metallic anode and more specifically a lithium metal anode. A lithium metal anode includes a piece of lithium metal, which may be formed as a strip, plate, or piece of lithium metal foil. The lithium metal anode in some implementations may have a thickness of about 5-150 microns. In some implementations, the lithium metal is mounted on a copper foil current collector. Regardless of the exact composition of the lithium metal anode, which may vary, the level of lithium purity is preferably substantially high. Lithium metal has a high specific energy, typically an order of magnitude greater than the graphite anode of rechargeable batteries in public use. Lithium-magnesium alloys are other preferred examples of metallic anodes. In some examples, the lithium metal anode may be stabilized by the electrolyte 100. Stabilization of the lithium surface of the lithium metal anode may be achieved by formation of a stable and robust solid electrolyte interphase (SEI). In some implementations, stable SEI formation may be achieved by reaction of the electrolyte 100 with the lithium surface of the lithium metal anode. The preferred lithium rich electrolyte can partially decompose on contact with the negative electrode active material to form fluoride and sulfur-rich lithium species that enhances the lifetime of the electrode by forming an unreactive layer on the electrode that inhibits further electrolyte decomposition and formation of dendrites. In such embodiments, the SEI structure, stability, and/or properties may depend on the electrolyte chemistry and physical properties.

### Cathode

The cathode 300, or positively charged electrode, of a preferable embodiment is typically in the form a strip comprised of an active material that may reversibly intercalate ions, at least one binder 310, and at least one conductive additive 320. The positive electrode has a thickness typically in the range of 50-120 microns and a density of at least approximately 2.4 g/cm3. By weight, the active material constitutes at least 93% of the cathode 300, the binder constitutes 0.5-5% of the cathode 300, and the conductive additive(s) constitute about 0.1-4% of the cathode 300.

The active material typically consists of a metal oxide, metal phosphate, metal fluoride, or a combination thereof. The active material typically undergoes minimal structural changes or release of gaseous byproducts at temperatures at or below 160° C. The active material may be a material composed of Li, Ni, Mn, Co and oxygen. More preferably, the material may include compounds composed of LiNiₓMn_{y}Co_{z}O₂, where x ranges from 0.3-0.9, y ranges from 0.05-0.3, and z ranges from 0.05-0.3. The active material secondary particle size ranges from 4 microns to 28 microns. In one preferred implementation the ratio is 5:3:2 (i.e., LiNi_{0.5}Mn_{0.3}Co_{0.2}O₂). In alternative embodiments, the metal oxide cathode 300 may be comprised of lithium iron phosphate or lithium nickel manganese cobalt (NMC) oxide with other common ratios (e.g. 1:1:1, 6:2:2, or 8:1:1). In preferred variations, the cathode 300 composition may be specifically designed to remain stable at temperatures up to and above 160° C.

Conductive additives 320 of the cathode 300 can include electronically conductive carbon-based materials. In one variation, the conductive additive 320 can be conductive graphite and/or carbon black. Other alternatives may include other typical lithium ion carbon additives.

In addition to the active material, the cathode mixture includes a binder 310. The binder 310 functions to maintain the active material bound to the carbon additives and current collector. A preferred embodiment for the binder 310 is preferably a polyimide. Polyimide is a preferred binder 310 due to its compatibility with the preferred electrolyte 100 and polyimide's specific mechanical and chemical properties. Polyimide is novel in the field of rechargeable batteries: it is easier to process as thin cathode coats than polytetrafluoroethylene (PTFE), is mechano-stable at high temperatures, has a glass transition point of greater than 300° C., has shrinkage of less than 0.5% after 60 minutes at 150° C., does not lose function at high temperatures, and exhibits minimal swelling and softening in contact with the electrolyte 100. Alternative binders, such as Polyamide-imide, Polyvinylidene Fluoride, Carboxymethyl cellulose, Ethylene-(propylene-diene monomer) copolymer, Polyacrylates, Styrene-butadiene rubber, Polytetrafluoroethylene, and any others binders also compatible with the desired electrolyte 100 may be chosen.

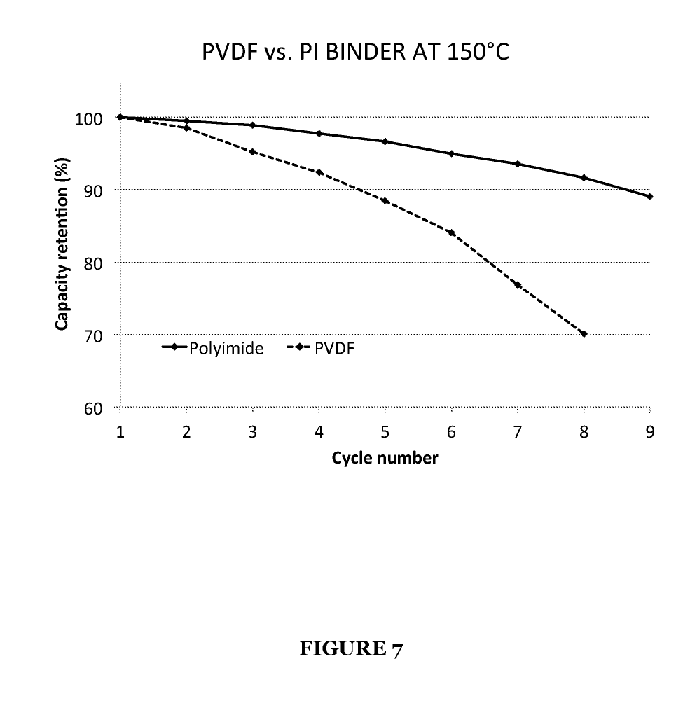

As shown in FIG. 7, a battery such as the one described herein using a polyimide binder can achieve significant improvements in capacity retention compared to other more conventional binders like polyvinylidene fluoride (PVDF). While the polyimide binder can retain around 90% capacity after 9 cycles, more conventional approaches may lose around 30% of capacity after only 8 cycles.

### Casing

As discussed, the battery casing 500 can preferably function to provide a protective packaging to make the battery suitable for use. An outer casing can be formed into a variety of battery structure form factors such as a button cell battery structure, a spiral-wound battery structure, or a pouch cell battery. In particular for high temperature use, the battery preferably includes a high temperature battery casing.

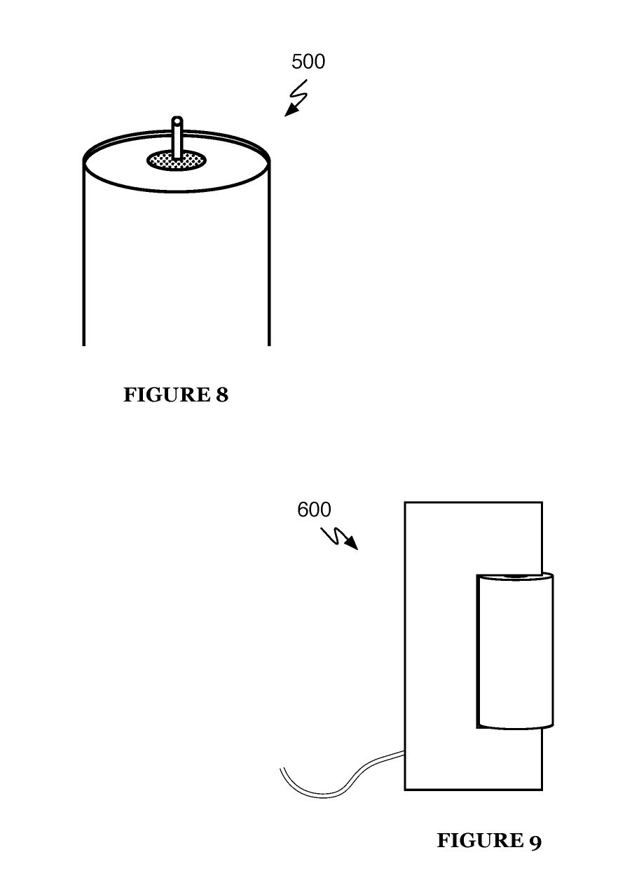

A high temperature battery casing functions to package the internal battery system for high temperature usage which may include temperatures greater than 50° C., though the battery may additionally remain operational at room temperatures or below. As shown in FIG. 8, a high temperature battery casing can include a metal outer casing enclosing the battery internals. The metal casing in some varieties is a steel-based material and serves as the negative contact, but other suitable materials may alternatively be used. A high temperature battery casing can additionally include an electrical contact region that includes a positive contact pin circumscribed by a glass-to-metal seal as shown in FIG. 8. The positive contact pin preferably extends out from the surface of the battery casing. A negative contact is preferably the material elsewhere in the electrical contact region, such as the metal surface surrounding the glass-to-metal seal and the metal casing itself. The glass-to-metal seal is preferably a ring that surrounds the positive contact pin. The glass-to-metal seal is preferably an electrical insulator. The glass-to-metal seal may additionally have thermal expansion properties matched to the material used in the battery casing, at least for the desired operating temperature ranges. Matched thermal expansion can function to prevent leaks and other mechanical failures in the battery.

In certain examples, a button cell battery may be manufactured to deliver 10 mWh as shown in FIG. 3. In a preferred implementation, the anode 200 may be a lithium metal anode as described above. In a preferred implementation, the cathode may be a cathode as described above. In a preferred implementation, the separator 200 may be a separator system as described above. As illustrated, the button cell battery may include an aluminum spacer, a stainless-steel spacer, and a stainless-steel spring.

In certain embodiments, a spiral-wound DD-format cell battery, as shown in FIG. 1, may produce a nominal voltage of approximately 3.7 volts, provide approximately 80 Wh of energy, be non-flammable, operate up to 160° C. or more, and be rechargeable. Alternative spiral-wound formats may alternatively be used.

In some embodiments, a pouch cell battery, as shown in FIG. 4, may be formed by wetting and compressing electrodes to achieve good contact and low resistance. In various embodiments, a metal foil and tabs of the pouch cell battery may be welded together. In certain embodiments, the pouch cell battery may include stacked electrodes configured to deliver from 40 mWh in a 2×3 cm format to 8 Wh in a 10×12 cm format. In one embodiment, two to twenty electrodes of the pouch cell battery may be assembled and stacked following a Z fashion folding in pouch laminate or pre-formed pouch laminate. In certain embodiments, the electrolyte 100 may be injected into the pouch cell battery before vacuum sealing the pouch.

As shown in the cross-sectional diagram of an exemplary battery in FIG. 2, the battery can include a metallic anode 200, a polymer separator 400, an ionic liquid electrolyte 100, and a metal oxide cathode 300. The components of the battery may be the preferred components described herein.

The system may additionally include a charger system 600, which functions to recharge the battery as shown in FIG. 9. The charger system 600 is preferably electrically coupled to the battery and then the battery is operated in a charging mode to re-energize the battery for a subsequent use in powering an electrical system. As discovered by the applicants, some variations of the battery experience enhanced rechargeability (in amount of recharge and/or number of recharge cycles) when charged at an elevated charging temperature. In some variations, the charger system 600 is an elevated temperature charging system that may include a heater element, which functions to charge the battery at an elevated temperature. The heater element can preferably be a regulated heating element controlled and configured to set and/or maintain a battery at particular temperatures while in a charging mode. In one implementation the elevated temperature charging system 600 is configured to set the temperature of the battery between 70-120° C. For example, the elevated temperature charging system 600 may charge the battery at a temperature of at least 80° C. The battery system may be configured to alter the charging temperature set by the heater element over a charging cycle. For example, the heater element may be configured to set a first temperature at one period in a charging cycle and a second temperature at a second period in the charging cycle. The charger system 600 may additionally be configured to apply a charging cycle tuned to the particular component materials and chemicals used in the battery.

The battery is preferably operable in at least a charging operating mode and a discharging mode (i.e., an active use mode). The battery may additionally have a standby mode where the battery is not in active use. As discussed, the battery is preferably operable at elevated temperatures during the discharging and standby operating modes. In other words, a battery not in active use can be exposed to high temperature conditions, and the same battery may be used in high temperature conditions. During a charging operating mode, the elevated temperature system may be configured to heat or maintain the temperature of the battery at least at 80° C.

The system may additionally include one or more electrical devices, wherein the electrical devices function to provide some electrical based functionality at least in part powered by the rechargeable battery or powering the rechargeable battery described herein. Exemplary electrical devices can include harsh environment sensors or devices (e.g., well and mining devices), medical devices (e.g., implantable medical devices that are powered by the battery and an inductive charger that charges the battery), wearable computing devices, and/or other suitable electrical devices. In one variation, the charger system 100 can be integrated into the electrical device such that the battery can be recharged through the electrical device.

As a person skilled in the art will recognize from the previous detailed description and from the figures and claims, modifications and changes can be made to the embodiments of the invention without departing from the scope of this invention as defined in the following claims.

We claim:

1. A system for a high temperature, high energy density secondary battery comprising:
an electrolyte comprising an ionic liquid solvent, and electrolyte salts;
a metallic anode;
a cathode, compatible with the electrolyte and comprising an active material, and a polyimide binder; and
a separator component that separates the cathode and anode.

2. The system of claim 1, wherein the electrolyte salt is a lithium salt with a concentration of greater than 10%, by weight, of the electrolyte.

3. The system of claim 2, wherein the lithium salt is lithium bis(trifluoromethanesulfonyl)imide.

4. The system of claim 1, wherein the ionic liquid solvent is a bis(trifluoromethanesulfonyl)imide-based ionic liquid solvent.

5. The system of claim 4, wherein the bis(trifluoromethanesulfonyl)imide-based ionic liquid solvent is 1-Butyl-1-methylpyrrolidinium bis(trifluoromethanesulfonyl)imide.

6. The system of claim 1, wherein the metallic anode is a lithium metal anode.

7. The system of claim 1 wherein the active material reversibly intercalates lithium ions; and wherein the cathode further comprises at least one carbon-based conductive additive.

8. The system of claim 1, wherein the metallic anode is a lithium magnesium alloy anode.

9. The system of claim 1, wherein the separator is a ceramic-coated polypropylene separator.

10. The system of claim 1, wherein the separator is a compound separator with at least two separator materials.

11. The system of claim 10, wherein the compound separator comprises a polyimide layer adjacent to the cathode and a ceramic-coated polypropylene layer adjacent to the anode.

12. The system of claim 1, further comprising a high temperature battery casing.

13. The system of claim 12, wherein the high temperature battery casing comprises of a steel-based negative contact casing with a positive contact pin circumscribed by a glass to metal seal.

14. The system of claim 1, further comprising an outer casing formed in a battery structure selected from the set including at least a button cell battery structure and a spiral-wound battery structure.

15. The system of claim 1, wherein the battery can charge and discharge at temperatures greater than 70° C.

16. The system of claim 1, wherein the battery can charge and discharge at temperatures between 25 and 160° C.

17. The system of claim 1, wherein over twenty charge-discharge cycles to 100% state of charge and 100% depth of discharge at temperatures between 100-160° C., the battery maintains greater than 70% capacity.

18. The system of claim 1, wherein the battery comprises a discharging operating mode; wherein in the discharging operating mode, the battery supplies at least 450 Wh/L over one full discharge when operated in the temperature range of 70° C.-160° C.

19. The system of claim 18, further comprising an elevated temperature charging system; and wherein the system comprises a charging operating mode; and in the charging operating mode, the elevated temperature charging system is configured to set the temperature of the battery to at least 80° C.

20. The system of claim 1, wherein the cathode is a cathode selected from the set of a metal oxide cathode, metal fluoride cathode, or a metal phosphate cathode.

21. A system for a high temperature secondary battery comprising:
an electrolyte comprising a bis(trifluoromethanesulfonyl)imide-based ionic liquid solvent and lithium salts, wherein the lithium salts comprises at least lithium bis(trifluoromethanesulfonyl)imide;
a lithium metal anode;
a cathode compatible with the electrolyte, the cathode comprising a metal oxide-based active material, a polyimide binder, and at least one carbon-based conductive additive;
a ceramic-coated polypropylene component that separates the cathode and anode; and
a high temperature battery casing.
